(19) United States
(12) Patent Application Publication
(10) Pub. No.: US 2011/0060693 A1
(43) Pub. Date: Mar. 10, 2011

(54) Vending Machine for Large Product Containers

(75) Inventors: Frank M. Consiglio, Las Vegas, NV (US); Jenna M. Consiglio, Las Vegas, NV (US); Steven W. Carroll, Acworth, GA (US); Richard Burney, Waco, TX (US); Larry E. Hieb, Murphy, TX (US); Walid Hassib Lel Aouar, Dallas, TX (US); Vishal Dali, Richardson, TX (US); Michael S. Behrend, Ft. Worth, TX (US); Randall S. Meyer, Dallas, TX (US)

(73) Assignees: Sanden Vendo America, Inc., Dallas, TX (US); CFL International, LLC, Las Vegas, NV (US)

(21) Appl. No.: 12/877,559

(22) Filed: Sep. 8, 2010

Related U.S. Application Data
(60) Provisional application No. 61/240,834, filed on Sep. 9, 2009.

(51) Int. Cl. G07F 11/34; G06F 17/00; B65D 83/00; G06F 7/00; B65G 11/08; B65G 11/20; A47B 81/00; G07F 11/00; F16F 1/00; G06Q 99/00

(52) U.S. Cl. 705/308; 221/1; 193/39; 221/10; 312/211; 312/198; 267/80

(57) ABSTRACT

The present invention provides machines, methods and apparatus for automatically vending, damping, delivering and returning large heavy product containers such as 5-gallon water bottles. In some embodiments, damping methods and apparatus are provided to gently transfer large heavy product containers from one level to another inside a vending machine. In some embodiments, methods and apparatus including adjustable support rails are provided for handling different sized large heavy product containers inside a vending machine. In some embodiments, delivery methods and apparatus are provided for use with large heavy product containers. In some embodiments, methods and apparatus for returning large product containers are provided. Some or all of these features may be provided in a single vending machine, or in multiple machines, and multiple features or machines may be controlled by a single computer processor.

This application claims the benefit of U.S. Provisional Application Ser. No. 61/240,834 filed on Sep. 9, 2009 which is incorporated herein by this reference.

### BACKGROUND OF THE INVENTION

1. Field of the Invention

The present invention relates to vending machines and their methods of operation, and more particularly to devices and methods used for the storage, return, damping, and delivery of large heavy product containers such as 3-gallon and 5-gallon water bottles.

2. Description of the Prior Art

There has been an explosion in every avenue of bottled water use in the United States and the world, driven in large measure by marketing designed to convince the general public of the safety and purity, and capitalizing on public concern about tap water quality. It is believed that more than half of all Americans drink some form of bottled or container filled water; and about one third of the public consumes it regularly. Sales have tripled in the past 10 years, to about $14 billion a year. The industry standard is approximately ten percent (10%), with the expectation that new technologies, such as the present invention, will help sustain this growth into the future. People spend from 240 to over 10,000 times more per gallon for all types of bottled or container filled water than they typically do for tap water.

The current global market for bottled or container filled water is estimated to be about $70 billion USD. Importantly, macroeconomic analysis shows a total available market of more than double this figure, or $159 billion. Leading areas of growth include Eastern Europe, China, Australia, and New Zealand. This mammoth category within the water industry is built upon many consumer trends, including: consumer's unmet demand for pure water in many economically developed nations, and the increase awareness towards living healthier by a growing number of people.

Currently, consumer demand for bottled water is met in a variety of ways. One way is through services which provide dispensers (water coolers) and also provide delivery and pick-up services, delivering full water bottles to be placed in the dispensers and picking up used empty bottles. Pick up and delivery services are expensive since the consumer must pay for the dispenser, the pickup/delivery service, and for the bottled water itself. This has led to making bottled water available in containers for retail purchase at retail markets. However, such bottled water is only available when the market is open for business, and the water is generally not made available in a cool, refreshing drinkable condition. An alternative way for providing bottled water is through water filling machines which allow consumers to bring in large empty water bottles to be refilled. While these refilling stations may be convenient, the water filters inside may not always provide the cleanest, purest water, and there is the risk of contamination if the consumer has not sufficiently cleaned the bottle being filled. It is therefore desirable to provide an automatic vending machine for providing large heavy product containers for holding fluids such as water that may be accessed at any time during the day or night.

Numerous automatic vending machines are known in the art for providing various kinds of products and product containers. However, relatively few existing vending machines are directed toward use with large, heavy product containers such as 3-gallon or 5-gallon water bottles. Maintaining and dispensing such large product containers presents unusual challenges because of the considerable weight associated with these containers when filled. A 5-gallon water container weighs approximately 41.73 pounds when filled. If as few as ten such bottles are to be stored for potential vending, the total weight is 417.26 pounds; if 25 such bottles are stored, the weight increases to over 1,000 pounds (1,043 pounds). If these heavy bottles are placed in a single queue, this entire pressure is borne by the hold-off mechanism. Moreover, as the lowermost bottle is dispensed, if the remaining bottles were to simply drop down, this could result in rupturing of the lower bottles and/or damage to the hold off mechanism because of the great weight.

U.S. Pat. No. 5,967,364 discloses a vending machine that may be adapted for use with large containers. However, the disclosure system having a oscillating member that alternatively holds off and allows dispensing of a product container. There is no damping mechanism to reduce or slow the movement of the containers when the lowermost container is delivered, and the oscillating hold off member could easily be damaged under the weight of the containers above.

U.S. Patent Publication No. 2002/0043509 discloses a storage rack for large water bottles having speed bumps to reduce the speed of the heavy moving jugs. U.S. Patent Publication No. 2006/0263188 discloses a support structure for holding a single large water bottle prior to insertion into water cooler. This invention utilizes one or more support pistons, but is not designed for use with multiple bottles. U.S. Patent Publication No. 2009/0140000 generally discloses an apparatus for supplying 3-gallon and 5-gallon water bottles, but provides no details regarding the manner by which such bottles are identified, selected, removed from storage, placed on conveyors or delivered. Various rack loaders and carts for large bottles are disclosed in U.S. Pat. Nos. 4,929,140, 5,074,013, 5,846,043, and 6,003,654 and in U.S. Patent Publ. No. 2008/0267744, but none of these patents or publications discloses any damping or individual bottle delivery mechanisms.

It is therefore desirable to provide automatic machines, methods and apparatus for use in reliably storing, transferring, vending and returning large heavy containers without damaging or rupturing the containers or spilling their contents.

### SUMMARY OF THE INVENTION

The present invention provides numerous solutions, systems, machines, devices and methods for reliably delivering and returning large heavy product containers (such as 5-gallon water bottles) automatically without rupturing or otherwise damaging the containers.

In some aspects of the present invention, an internal damping mechanism is provided as part of a larger apparatus for supporting large heavy product containers. In this aspect, a frame is provided for supporting a plurality of pairs of rails for holding the large product containers in a queue with the rails defining a path inside the frame having at least one turn. One or more damping mechanisms are provided at each turn for slowing down the movement of the product containers on the path. Each damping mechanism includes a panel having an end that is pivotally attached to the frame, one or more springs for urging the panel upward to an extended position, and a compressible support member such as an air, gas or oil filled piston, shock absorber, or spring mechanism attached underneath the panel to slow the movement of the panel when contacted by the heavy product container. This slows the downward movement of the container as it makes the turn, in order to avoid rupturing or damaging the container. In different embodiments of the invention, additional damping mechanisms may be provided at each turn in the path. In the preferred embodiments, two damping mechanisms are provided at each turn, one below the other.

In other aspects of the invention, a frame is provided that supports a plurality of pairs of adjustable rails for holding different sized large product containers. In these embodiments, the positions of one or both of the rails may be changed in order to accommodate different sized containers. For example and without limitation, the rails may be established at a certain separation space to support the shoulder and bottom of 5-gallon water bottles on their sides; one or both of these rails may be adjusted to define a shorter separation space in order to accommodate smaller 3-gallon water bottles. In these embodiments, additional, different or removable guides or panels are provided as part of the damping mechanism(s) for adjustable alignment with the adjusted position(s) of one or both of the rails.

Other aspects of the invention include methods of damping or controlling the transfer of large product containers from one level to another in a frame. In these embodiments, a plurality of large, heavy product containers are provided on a frame defining a path with at least one turn, and at least one damping mechanism is provided at each turn. As a product container makes a turn, it contacts a pivotally mounted panel that is being urged upward using one or more springs or other similar biasing devices. The panel is also supported by a compressible member such as an air, gas or oil filled piston, spring or shock absorber. The amount of air, gas or oil in the piston, or the strength of the shock absorber or spring is determined by the anticipated weight of the product containers and the speed at which they are to be allowed to move. The weight of the product container against the panel causes it to slowly move the panel downward, as the compressible member underneath the panel slowly compresses and gives way. This dampens or retards the downward movement of the container in order to avoid sudden jarring motion that could rupture or damage the container or those behind it. In some embodiments, a stop in the form of a bracket, pin, flange or other blocking or obstructing member may be provided underneath the damping panel to prevent it from going below a pre-determined position. Eventually, the panel will reach a lowermost position and the container will gently roll off, either onto another damper or onto a lower set of rails. Once the container is clear of the panel, the springs will return it to its upward, extended position to be ready to receive the next product container. In alternative embodiments, flanges may be provided on the damper panel to guide the position of the product container while in contact with the panel.

In alternative embodiments, a second damping mechanism is provided immediately below the first damping mechanism which operates in substantially the same way as the first damping mechanism. In particular, in these embodiments, a second pivotally mounted panel is provided that is being urged upward using one or more springs or other similar biasing devices. The second panel is also supported by a second compressible member such as an air, gas or oil filled piston, spring or shock absorber. The amount of air, gas or oil in the piston, or the strength of the shock absorber or spring is determined by the anticipated weight of the product containers and the speed at which they are to be allowed to move. The weight of the product container against the second panel causes it to slowly move the second panel downward, as the second compressible member underneath the panel slowly compresses and gives way. This further dampens or retards the downward movement of the container in order to avoid sudden jarring motion that could rupture or damage the container or those behind it. In some embodiments, a second stop in the form of a bracket, pin, flange or other blocking or obstructing member may be provided underneath the second damping panel to prevent it from going below a pre-determined position. Eventually, the second panel will reach a lowermost position and the container will gently roll off onto a lower set of rails. Once the container is clear of the second panel, the springs will return it to its upward, extended position to be ready to receive the next product container. In alternative embodiments, flanges may be provided on the second damper panel to guide the position of the product container while in contact with the second panel.

In other aspects of the invention, a unique delivery mechanism is provided at the end of a path at the lower end of the frame where the large product containers have been fed by gravity. In these embodiments, the delivery mechanism includes a pivotally mounted delivery tray for receiving the first (lower most/frontmost) large product container. These embodiments include two restraining or hold off members attached to the frame adjacent to the delivery tray. The first such hold off member is closest to the delivery tray, and is made of sturdy construction so as to hold off the first product container, and all product containers queued up behind it. The second hold off member is adjacent to the first, and is also made of sturdy construction so as to be able to hold off the second product container, and all product containers queued up behind it. At least one sensor or switch is provided in the delivery tray for detecting the presence of a product container in the tray and for detecting whether said tray is clear of blockage after a product container has been removed from the tray. A linear actuator, linkage, piston or other movable mechanical member attached to said the tray to cause it to open and close. A processor is provided to control the hold off members, and the linear actuator, and to react to input from the sensor(s) in the tray. In some embodiments, a second movable panel is provided in the tray, and the sensor(s) are provided between this panel and the tray, such that pressure on the panel triggers the sensors indicating the presence of either a product container or some other object in the tray.

In other aspects of the invention, methods for delivering a large product containers from an inclined queue are provided. In these embodiments, a processor receives an activation signal from a user interface that a product container is to be delivered. This is generally in response to a user making payment for the product. A sensor in the tray is used to detect whether a product container is in the tray, and also to detect whether any other object is in the tray. If a product container is already in the tray, the processor may simply cause the tray to be opened, allowing the user to remove the product container. The tray may then be closed, with the processor stopping the closing movement if an object is sensed in the tray. The processor may continue trying to close the tray at different intervals, sensing each time whether any object is in the tray which would prevent full closure.

In these embodiments, when the tray is empty, the processor uses a pair of movable members to move a product container into the tray. A first movable member is used to hold off the second and all subsequent product containers in the queue; and a second movable member is used to hold off the first and all subsequent product containers in the queue. The first movable member is activated to hold off the second and subsequent product containers, and the second movable member is released allowing the first product container to transfer by gravity into the tray. The second movable member is then reactivated to hold off any subsequent containers in said queue. Then, the first movable member is activated to release the second product and subsequent product container from the queue. This allows the second product container to move forward where it is held off by the second movable member. At this point, the tray is full and the product queue has been advanced. The tray may then be opened in response to a user request to deliver the product container in the tray.

In alternative embodiments, the tray may be empty until a user requests a product container. In these embodiments, the steps outlined above are carried out by the first and second movable members to advance the frontmost product container into the tray for delivery. After delivery, the queue may then be left in any of the following conditions: with the frontmost product container being held off by the first movable member, with the frontmost product container being held off by the second movable member, or with the frontmost product container in the tray.

In other aspects of the invention, different embodiments are provided for receiving returned (empty) large product containers. In these embodiments, a cabinet is provided that includes a lower storage area or bin that may be accessed through a large side door for removal of accumulated returned containers. An upper return door is provided in association with guide located adjacent to this door. The guide is used for laterally aligning product containers to be inserted through the upper door. A set of sensors are provided in conjunction with the guide to sense whether the product container has been properly oriented in the guide, and to determine the size of the container (e.g. 3-gallon or 5-gallon). In some embodiments, a first sensor may be provided in the neck area of the guide, and/or second sensor may be provided in the body of the guide where the base of a 3-gallon container would make contact, and/or a third sensor may be provided in the body of the guide where the base of a 5-gallon container would make contact. A processor in communication with the door and the sensor(s) can detect the size of the container being returned, and provide an appropriate credit to the user. Upon recognition of a properly aligned container, an acceptance mechanism receives the container, and provides a credit to the user. If the container is misaligned or otherwise not properly sensed, an appropriate message to this effect (e.g. “please check returned container position”) is provided to the user at the interface.

In related aspects of the invention, methods for returning large reusable product containers by a computer controlled system are provided. In these embodiments, a processor receives an activation signal from a user interface that a container is to be returned. The processor causes a closed return door to be released in response to this signal. A product container is then received through the door, and one or more sensors associated with the door sense the alignment of the container received. If the container is sensed as properly aligned, then it is deposited into a bin and a credit is provided to the user at the interface. If the container is sensed as not being properly aligned, then a signal is sent to the user interface to re-align the container and/or the container is rejected.

In some aspects of the invention, a product storage/delivery (vending) unit may be provided alone or in conjunction with a product return unit. In other aspects of the invention, dual or multiple product vending units may be provided alone or in conjunction with dual or multiple product return units. Ordinarily, multiple vending units and multiple delivery units may be controlled by a single user interface. However, in other embodiments, additional user interfaces may be provided for control of single, dual or other groups of vending units and/or return units. In multiple unit embodiments, all vending units may be configured to deliver the same sized containers (e.g. all units vend 5-gallon containers), or one or more units may be configured differently from the other(s) to provide different sized containers (some units vend 3-gallon containers, and others vend and 5-gallon containers.). Similarly, the return units be configured to receive the same or different sized containers (e.g. all units receive 5-gallon containers, or may also receive 3-gallon), or one or more return units may be configured differently from the other(s) to receive different sized containers (some units receive 3-gallon containers, and others receive and 5-gallon containers), or the same return may receive either size container (either a 3-gallon or 5-gallon). Multiple vending and multiple return units, and different combinations of vending and return units, are contemplated within the scope of the invention, all of which may be operated by a single processor.

In particular embodiments, the frame may preferably be configured to hold 25 product containers, and the delivery bin may hold up to 15 containers. Of course, other numbers of product containers are contemplated within the scope of the invention, depending on the space available and the size of the product containers in use.

In preferred embodiments, the payment system should use either debit or credit cards, not cash. However, currency or coin operated payment interfaces may be provided. Ordinarily, interactive LED screens or multi character display modules are used to instruct the consumer, but any suitable display may be used.

In a typical sequence, after card acceptance, an LED screen or other display prompts the user if a container is to be returned. If the answer is yes, the user follows the return procedure to obtain a credit. If not, the user proceeds to make a purchase. Assuming there is a return, the user will then be prompted to open the return door, insert the empty bottle to be returned, and then close the door. If the bottle is sensed as being properly oriented, it will be accepted and the user will be given a credit at the user interface. The bottle will then be dropped into a storage bin. If the bottle is not properly oriented, the user prompted to try again.

Assuming the return is accepted, the user interface (e.g., LED screen or display) will then prompt the consumer regarding any credit provided for the return, and instruct the user to pay any balance due and then retrieve a full bottle from the tray at the end of the vending unit. When the processor gets a signal to deliver a full water bottle to consumer, the tray is automatically tilted out with a bottle for the consumer to lift out. A weight-sensitive panel in the tray detects removal of bottle, and thereafter automatically closes the tray. If any additional weight is added to door (e.g., someone manually holds tray open or places hand in tray), in some embodiments all machine mechanisms may automatically stop and reverse (reopening the tray) to allow any obstruction to be removed. After the obstruction is removed, the tray will continue to shut.

Thereafter, the vending unit will cause a bottle indexing mechanism, which may include a vibrator, to prepare the next bottle for delivery. In these embodiments, the vibrator will operate for two to three seconds to be sure all bottles start to roll/advance forward on the specially designed rail system. The full bottles will advance one space closer to the tray, along a specially designed rail system, with the bottommost bottle landing in the tray, ready for the next purchase.

When full bottles need to be added to the vending unit, an upper left end door is opened. In some embodiments, pulling open this door will activate the damper system to slow bottles as they roll down the specially designed rail system. However, in most embodiments, the damping system is automatically and continuously engaged. In some embodiments, if bottles stop on the rail system, there will be a manual override button to engage a vibrator system to shake lose any stuck bottles. When the vending unit is full, the delivery person shuts and locks the loading door, and the machine is then ready to operate again.

It is to be noted that in some embodiments the walls of the vending unit are insulated, including the exterior panels of the delivery tray and loading doors. Climate control systems (heating or cooling) may be provided inside the vending units to maintain the temperature of the product containers. It is also to be noted that the first and/or second container hold off systems are designed to be constructed of sturdy materials in order to hold off potentially 1,000 pounds (or more) of filled product containers.

It is therefore an object of the present invention to provide machines, devices and methods for use in automatically vending large heavy containers without damaging or rupturing the containers.

It is also an object of embodiments of the present invention to provide methods and apparatus for automatically damping or slowing the movement of large heavy product containers inside a vending machine.

It is also an object of embodiments of the present invention to provide methods and apparatus for automatically delivering large heavy product containers from inside a vending machine.

It is also an object of embodiments of the present invention to provide methods and apparatus for automatically returning empty large product containers to a machine.

Additional objects of the invention will be apparent from the detailed descriptions and the claims herein.

### BRIEF DESCRIPTION OF THE DRAWINGS

FIG. 1 is a perspective view of an embodiment of a machine of the present invention.

FIG. 2 is a left side view of an embodiment of a machine of the present invention.

FIG. 3 is a front view of an embodiment of a machine of the present invention.

FIG. 4 is a perspective view of an embodiment of an internal frame structure of an embodiment of a machine of the present invention, loaded with 5-gallon containers.

FIG. 5 is a side view of an embodiment of an empty internal frame structure of an embodiment of a machine of the present invention.

FIG. 6 is a perspective view of an embodiment of an empty internal frame structure of an embodiment of a machine of the present invention.

FIG. 7 is a detailed side view of an embodiment of a damping mechanism of the present invention in a fully-extended condition.

FIG. 8 is a detailed side view of the damping mechanism of FIG. 7 in a fully-compressed condition.

FIG. 9 is a detailed perspective view of an embodiment of a rail system adjacent to damping mechanisms of the present invention.

FIG. 10 is a detailed perspective view of an embodiment of a damping panel of the present invention showing exemplary flanges and positioning for an embodiment of an adaptor bracket.

FIG. 11 is a detailed perspective view of the embodiment of FIG. 11 showing attachment of an embodiment of an adaptor bracket to an embodiment of a damping panel.

FIG. 12A is a detailed side view of an embodiment of a damping mechanism of the present invention showing an embodiment of a first damper in an extended position upon receipt of a bottle.

FIG. 12B is a detailed side view of the embodiment of FIG. 12A showing the first damper in a different position after having been compressed by the weight of a bottle, and an embodiment of a second damper in an extended position upon receipt of the bottle.

FIG. 12C is a detailed side view of the embodiment of FIG. 12A showing the second damper in a different position after having been compressed by the weight of the bottle.

FIG. 12D is a detailed side view of the embodiment of FIG. 12A showing the second damper in an extended position following release of the bottle.

FIG. 13 is a detailed perspective view of an embodiment of a product container delivery mechanism of the present invention.

FIG. 14 is a detailed perspective view of an embodiment of a product delivery tray of the present invention.

FIG. 14A is a cross sectional view of an embodiment of a delivery tray of the present invention.

FIG. 15 is a detailed side view of an embodiment of a delivery mechanism of the present invention.

FIG. 16 is a detailed perspective view of the embodiment of FIG. 15.

FIG. 17A is a detailed side view of an embodiment of a delivery mechanism of the present invention showing an empty delivery tray.

FIG. 17B is a detailed side view of the embodiment of FIG. 17A showing a bottle transferred into the delivery tray.

FIG. 17C is a detailed side view of the embodiment of FIG. 17A showing a second bottle transferred into a first position behind delivery tray.

FIG. 17D is a detailed side view of the embodiment of FIG. 17A showing the delivery tray opening to deliver a bottle.

FIG. 17E is a detailed side view of the embodiment of FIG. 17A showing the delivery tray in a closed position following removal of a bottle from the delivery tray.

FIG. 17F is a detailed side view of the embodiment of FIG. 17A showing the second bottle transferred into the delivery tray.

FIG. 17G is a detailed side view of the embodiment of FIG. 17A showing a third bottle transferred into a first position behind delivery tray.

FIG. 18 is a perspective view of an embodiment of a product return apparatus of the present invention with bin door open.

FIG. 19 is a perspective view of an embodiment of a product return apparatus of the present invention with bin door closed.

FIG. 20 is a front side view of an embodiment of a product return apparatus of the present invention.

FIG. 21 is a sectional view along line B-B of FIG. 20.

FIG. 22 is a detailed inside perspective view of an embodiment of a product return apparatus of the present invention.

FIG. 23 is a perspective view of an embodiment of a frame assembly of the present invention for supporting product container guide rails.

FIG. 24 is a perspective side view of an embodiment of a rail of the present invention.

FIG. 25 is a perspective bottom view of an embodiment of a rail of the present invention.

### DETAILED DESCRIPTION

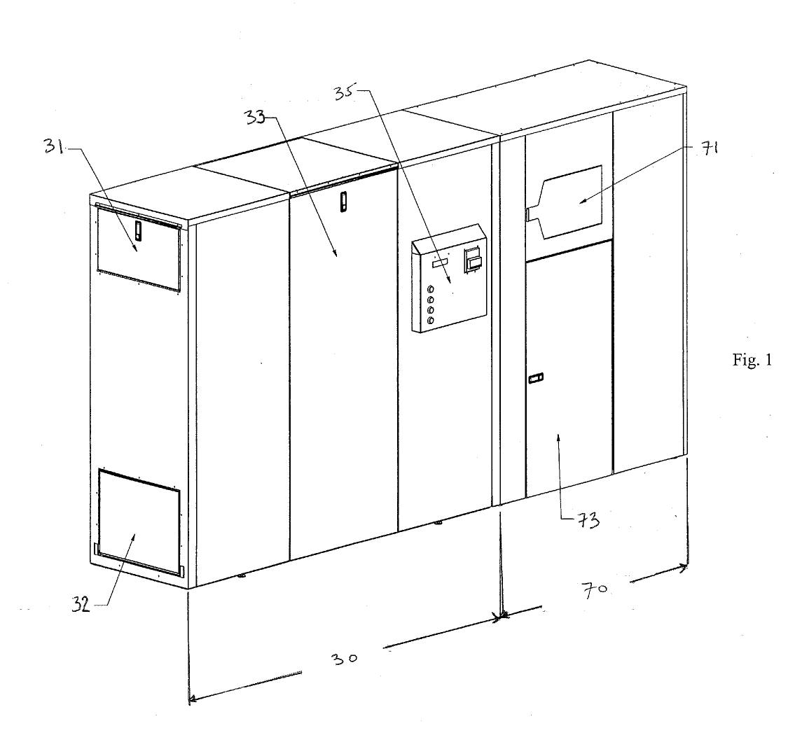

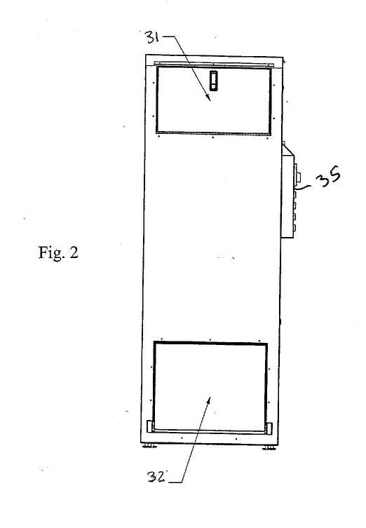

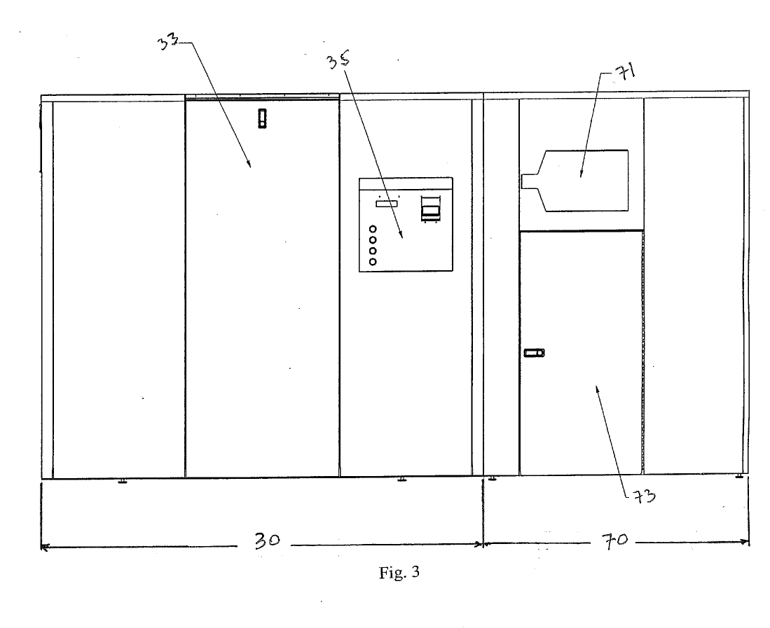

Referring to the drawings wherein the same reference numeral may be used to designate different parts throughout the several views, and referring particularly to the illustrated exemplary embodiment of FIGS. 1-3, it is seen that the apparatus of the invention includes a vending unit 30 which in some embodiments may also include a product return unit 70. Embodiments of the vending unit 30 include an upper door 31 for loading unit 30 with large containers, and a lower product delivery tray 81 having an outside panel 32 that may be flush or nearly flush with the outer surface of vending unit 30 when tray 81 is closed, as shown in FIGS. 1 and 2. A main access door 33 is also provided that allows access to the interior of unit 30 for repair, maintenance, or removal of product containers. Doors 31 and 33 are preferably provided with a lock to prevent unauthorized access. A consumer interface panel 35 is also provided on unit 30, which includes such features as product selection, payment options, optional product return options and the like. Vending unit 30 is preferably insulated, and provided with a cooling and/or heating system with temperature controls to keep product containers inside unit 30 at a desired temperature, compensating for changing outside ambient air temperatures.

An optional product return unit 70 may be provided as a stand alone unit, or provided in conjunction with one or more vending units 30. As shown in the illustrated exemplary embodiments of FIGS. 1, 3, and 18-22, an exemplary return unit 70 includes an upper door 71 leading to a bin 74 for receiving empty returned containers. Door 71 is provided behind an opening 72 that is preferably shaped in the form of a bottle, preferably having the bottle neck area to one side, and the bottle bottom area to the other side, as shown. A second door 73 is provided on return unit 70 to allow access to the interior of bin 74 to remove returned containers that have accumulated inside. Door 73 is preferably provided with a lock to prevent unauthorized access.

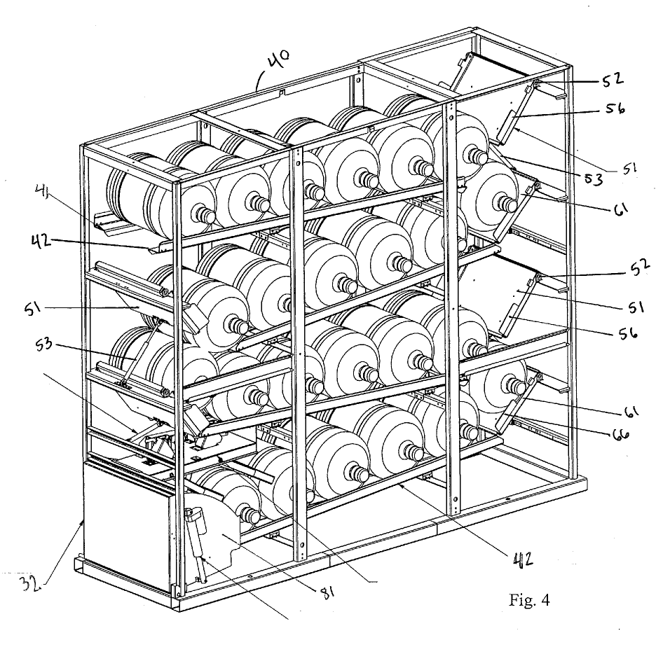

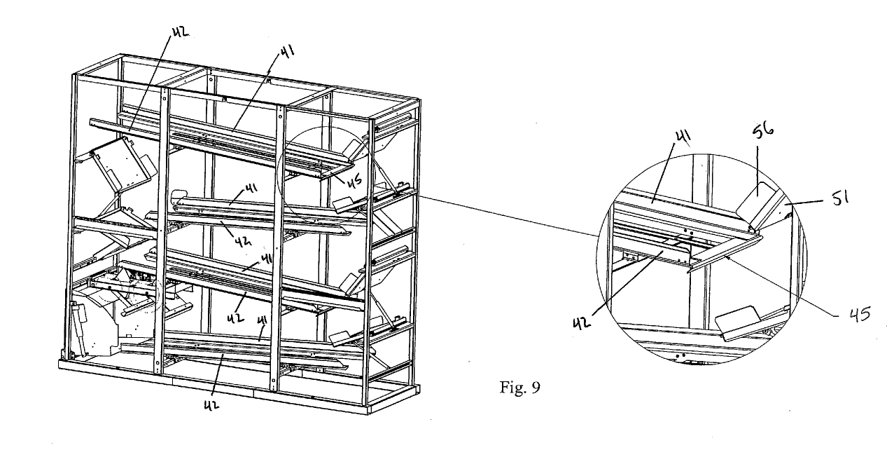

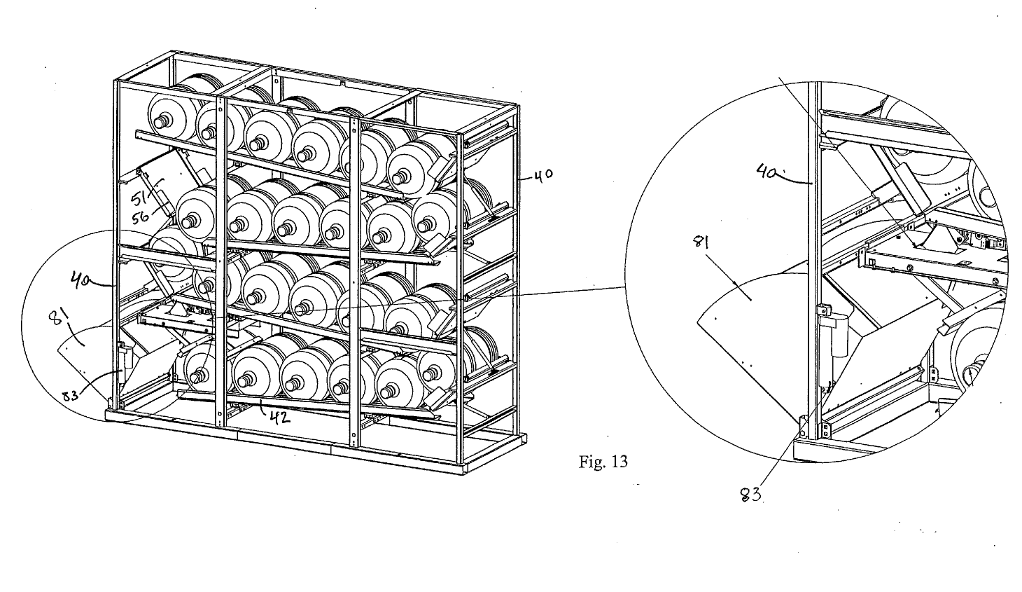

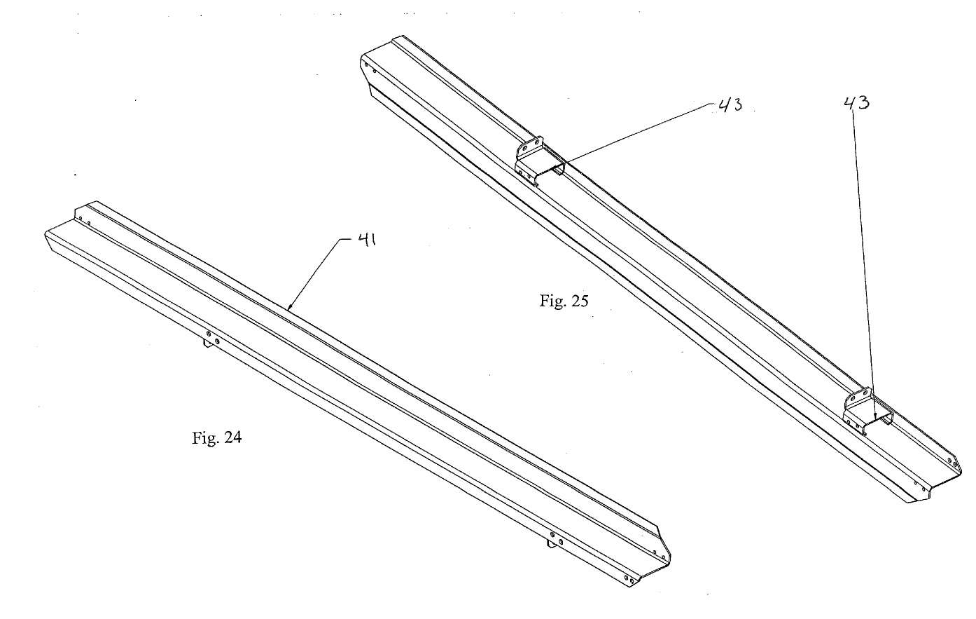

FIGS. 4 and 23 illustrate embodiments of a frame structure 40 that is provided inside vending unit 30 for holding large product containers to be vended. A plurality of pairs of rails 41, 42 are provided for mounting onto frame 40 as shown, for example, in FIGS. 6 and 9. Mounting of a rail 41, 42 to frame 40 may be accomplished using brackets 43 or the like, illustrated in FIGS. 24 and 25. Pairs of rails 41, 42 are used to support product containers on frame 40 as shown, for example, in FIGS. 4 and 13. It is preferred that rails 41, 42 be mounted on frame 40 at a slightly downward angle so that product containers deployed on the rails will be urged forward (downward) by gravity from the upper loading door 31 to the lower product delivery tray 81. In some embodiments such as those illustrated in several of the exemplary drawings, rails 41, 42 may be arranged in one or more rows that may form a zig-zag or serpentine pattern, although other suitable arrangements of the rails may be used. For example, and without limitation, embodiments of the rail system may include only a bottom pair of rails, and a second pair of rails immediately above the bottom pair such that there is only a single turn (with a damping mechanism) to be made by product containers before exiting the vending unit 30. Such embodiments provide the desired damping before the product containers are delivered, while allowing significant additional space for storing product containers to be vended.

The positions of rails 41, 42 of the present invention may be adjusted to accommodate different sized containers. The illustrated exemplary embodiment of FIG. 4 shows rails 41, 42 adjusted to a maximum position in order to accommodate 5-gallon water bottles. However, the positions of one or both of rails 41 and/or 42 may be adjusted to accommodate smaller bottles. For example, and without limitation, the positions of shoulder rails 42 may be adjusted to receive the shoulders of shorter 3-gallon water bottles. Alternatively, and without limitation, the positions of bottom rails 41 may be adjusted to receive the bottoms of shorter 3-gallon water bottles.

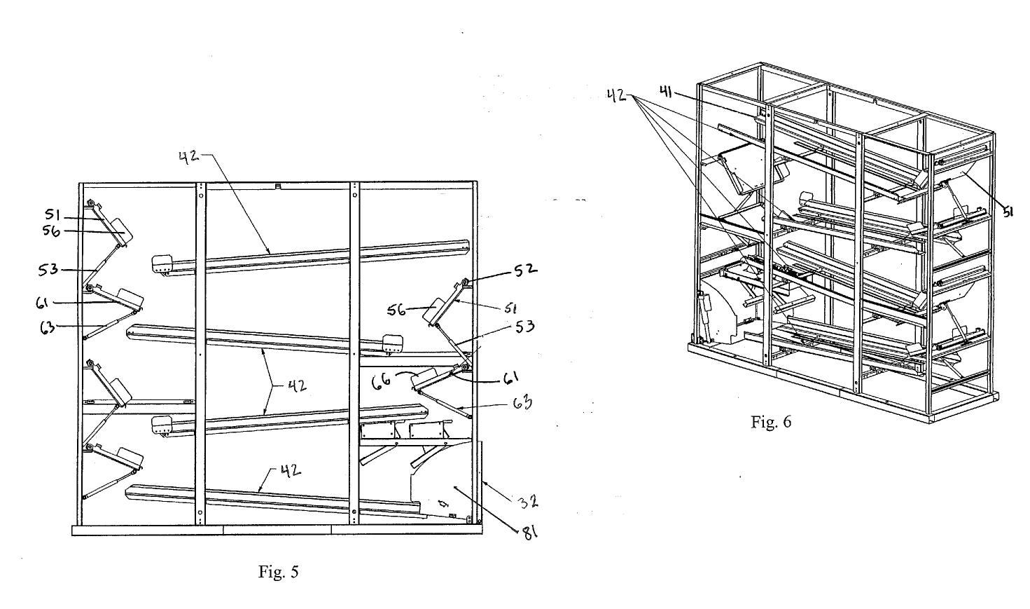

Because large fluid-filled product containers (such as 3- and 5-gallon water bottles) tend to be heavy, it is important to control the movement of such filled containers inside vending unit 30. This is accomplished using a unique damping system, embodiments of which are illustrated in FIGS. 4-12. In preferred embodiments, one or more damping mechanisms are provided at each turn in the path for product containers inside vending unit 30. At each turn, product containers are transferred from an upper level to a lower level. It is to be appreciated that without damping, transitions of heavy product containers from one level to another could occur with great force sufficient to rupture the containers or otherwise cause damage to the components of the vending unit 30.

At least one upper damper, and preferably both an upper and a lower damper are provided at each transition of product containers from an upper level to a lower level inside vending unit 30. Each upper damper includes a panel 51 that is pivotally mounted at one end to frame 40 so that it may move in an arcuate path around the pivot 52. At least one spring 54 (not shown) is provided with each panel 51 to urge the panel to an extended (upward/outward) position. At least one compressible support member 53 is provided below each panel 51, and may be in the form of an air, gas or oil-filled cylinder, shock absorber, hydraulic or pneumatic piston, spring, spring assembly, or the like, or combinations thereof. Each compressible support member 53 is preferably calibrated so as to slowly compress below panel 51 when under the known weight of a filled heavy container in order to delay, slow or otherwise retard the movement of such a heavy product container. It is to be appreciated that if support member(s) 53 is too strong, it will not be moved by the product container; and if support member(s) 53 is too weak, it will move too quickly under the weight of the product container. An optional stop 55 may be provided underneath panel 51 to establish a bottom position for movement of panel 51 to prevent downward movement (bottoming out) of panel 51 beyond the stop. Stop 55 may be in the form of a bracket, pin, flange or other blocking or obstructing member. One or more flanges 56 are provided along edges of panel 51 to guide product containers on panel 51 and align them with rails 41, 42 as they make the transition from an upper level to a lower level inside vending unit 30. In some embodiments, a removable end piece 45 is provided between rails 41, 42 as shown in FIG. 9.

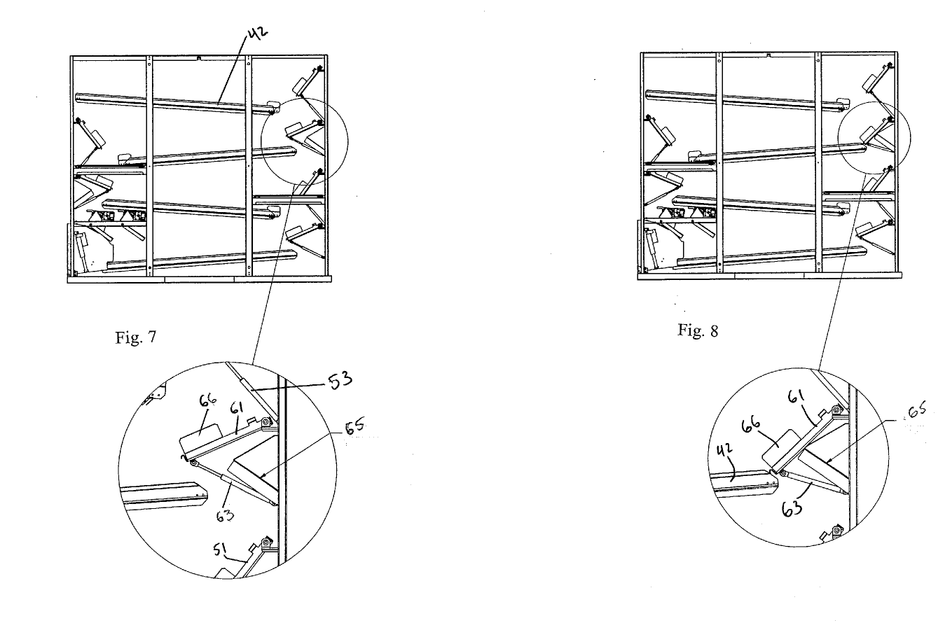

In preferred embodiments, a second lower damper is provided beneath each upper damper at each turn on the product container path, in order to more gracefully transition product containers from an upper level to a lower level. See FIGS. 8 and 9. Each second damper includes a panel 61 that is pivotally attached to frame 40, having at least one spring 64 (not shown) to urge it in an upward, extended position. The extended position of each second damper panel 61 is preferably slightly farther out than the extended position of the related upper damper panel 51 in order to more readily receive a heavy product container rolling off the upper panel (see FIG. 7). At least one compressible support member 63 is provided below each panel 61, and may be in the form of an air, gas or oil-filled cylinder, shock absorber, hydraulic or pneumatic piston, spring, spring assembly, or the like, or combinations thereof. Each compressible support member 63 is preferably calibrated so as to slowly compress below panel 61 when under the known weight of a filled heavy container in order to delay, slow or otherwise retard the movement of such a heavy product container. It is to be appreciated that if support member(s) 63 is too strong, it will not be moved by the product container; and if support member(s) 63 is too weak, it will move too quickly under the weight of the product container. An optional stop 65 may be provided underneath panel 61 to establish a bottom position for movement of panel 61 to prevent downward movement (bottoming out) of panel 61 beyond the stop. Stop 65 may be in the form of a bracket, pin, flange or other blocking or obstructing member. One or more flanges 66 are provided along edges of panel 61 to guide product containers on panel 61 and align them with rails 41, 42 as they make the transition from an upper level to a lower level inside vending unit 30.

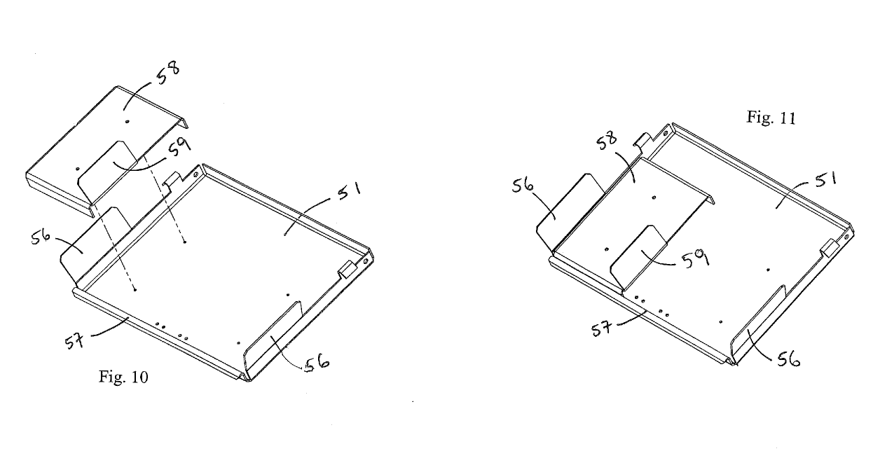

In some embodiments, as discussed above, the positions of either rails 41 or 42 may be adjusted to accommodate different sized containers. In those situations where a smaller container is to be accommodated (e.g., a 3-gallon water bottle), a corresponding removable guide 58 is provided that may be temporarily installed on damper panels 51 (and 61) to guide the smaller bottle as it travels through the damping mechanism(s), as shown in FIGS. 10-11. Guide 58 includes a flange 59 corresponding to flange 56 (or 66) of plate 51 (or 61). It is to be appreciated that one or two guides 58 may be provided for alignment with one or both of rails 41, 42 depending on their adjustment. FIGS. 10-11 also illustrate an additional optional flange 57 that may be provided on the front of damping panels 51, 61 that allow panels 51, 61 to more smoothly receive and transfer product containers during the damping process.

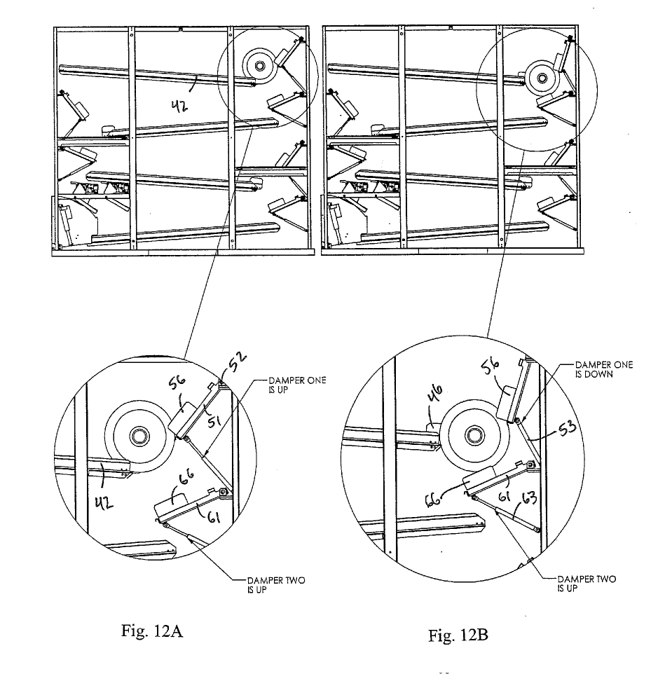

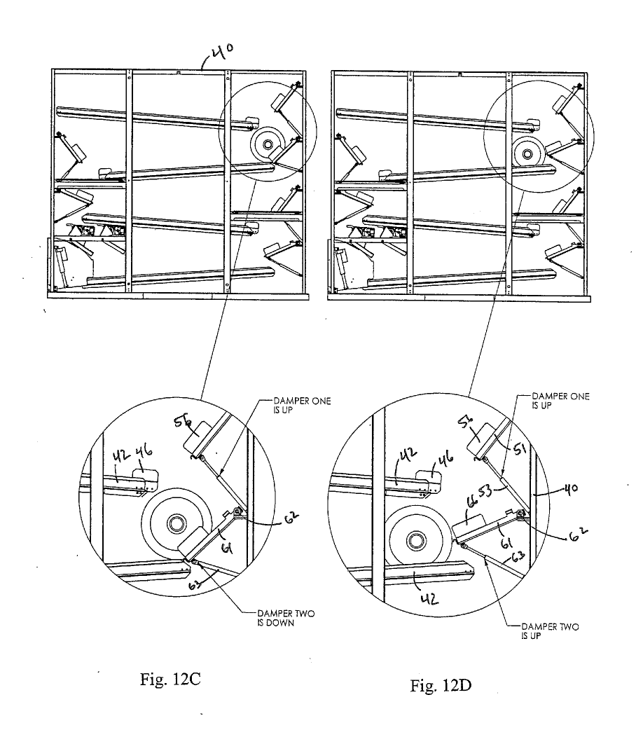

FIGS. 12A-D depict a set of views of an exemplary embodiment of a dual damping mechanism in operation. It is to be noted that, among other things, the embodiment shown in these illustrations does not include optional stops 55, 65 (shown in FIGS. 7-8). Referring first to FIG. 12A, a heavy product container travels down rails 41, 42 until it crosses end piece 45 and then makes contact with upper panel 51. End piece 45, rail guides 46 and flanges 56 prevent the orientation of the container from becoming skewed, and guide it onto panel 51. Then, panel 51 slowly moves downward in an arcuate direction around pivot 52 under the weight of the product container, as allowed by compressible support member(s) 53, until panel 51 reaches a stop 55 (not shown) and/or the product container rolls off, as shown in FIG. 12B. Once panel 51 is free of the product container, spring(s) 54 move panel 51 upward to return to its original extended position awaiting the next product container, as shown in FIG. 12C. Meanwhile, in the illustrated embodiment shown in FIG. 12C, the product container is received by panel 61 of the second damping mechanism. Panel 61 slowly moves downward in an arcuate direction around pivot 62 under the weight of the product container, as allowed by compressible support member(s) 63, until panel 61 reaches a stop 65 (not shown) and/or the product container rolls off onto rails 41, 42. Once the container rolls off, spring(s) 64 move panel 61 upward to return to its original extended position awaiting the next product container, as shown in FIG. 12D.

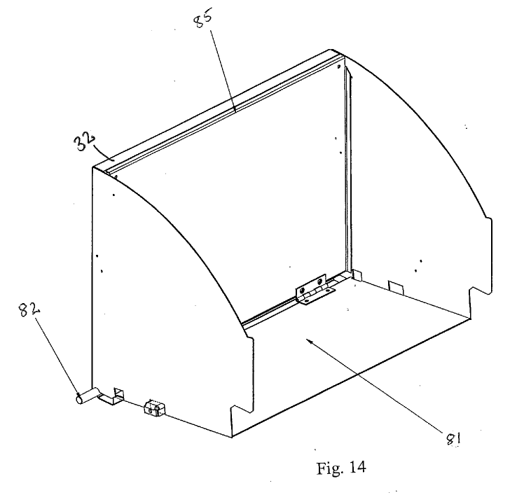

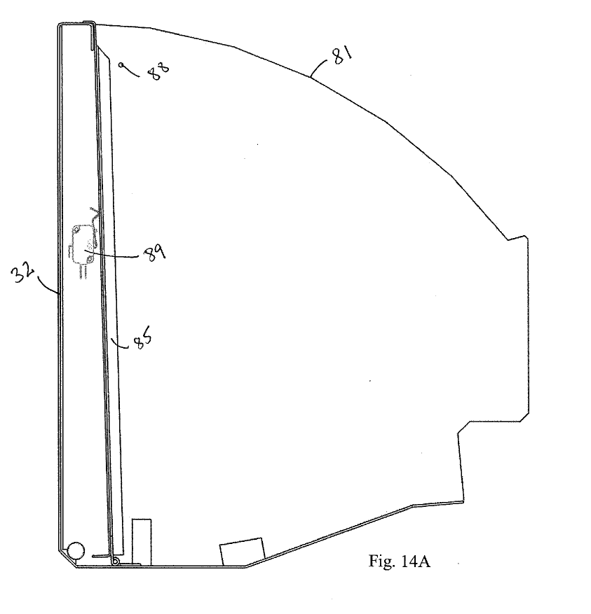

An exemplary embodiment of a product delivery system is illustrated in FIGS. 13-17. Embodiments of the invention include a delivery tray 81 pivotally attached at 82 to frame 40, as shown in FIG. 13. Tray 81 includes an outer panel 32 which fits flush or nearly flush with the outside wall of vending unit 30 when tray 81 is closed. Tray 81 is large and sturdy enough to receive a large heavy product container (e.g., a 5-gallon water bottle), and to move about pivot 82 while holding such a container. Movement of tray 81 is accomplished using a linear actuator 83 or other motion imparting device, such as a motor, linkage, cam, piston or the like. Tray 81 is preferably made of metal. A movable, spring-loaded interior panel 85 is provided in tray 81 as shown in FIG. 14. At least one sensor 89 is provided between panel 85 and panel 32 of tray 81. Sensor 89 may be a switch or other pressure sensitive device. When a large heavy product container is deposited in tray 81 (the condition shown in FIG. 14A), movable panel 85 is pressed against sensor 89 which sends a signal to a processor that an object is in the tray. The tray may then be opened by the operation of actuator 83 controlled by a processor. When the container is removed from tray 81, spring(s) (not shown) move panel 85 to its original position releasing pressure from sensor 89, which is understood by the processor that the tray is empty. Tray 81 may then be closed. Upon closing, if an object is encountered in tray 81 (such as a hand, arm or purse of a user), movable panel 85 will be pressed against sensor 89 sending a signal to a processor that an object is in the tray. This will cause the processor to stop movement of and reopen the tray until pressure is released from sensor 89 indicating that the tray is empty and can be closed. A stop 88 may be provided on tray 81 to prevent panel 85 from being urged to far forward by the spring(s).

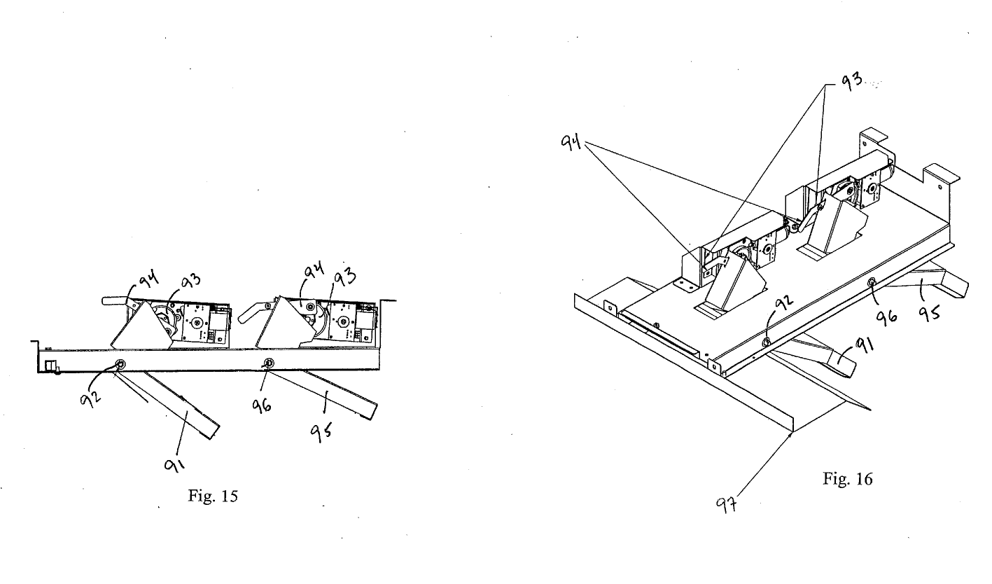

An exemplary embodiment of a hold off and delivery mechanism is illustrated in FIGS. 15-16. The hold off mechanism includes two similar devices, one for holding off the frontmost bottle in the queue, and another for holding off the next (and remaining) bottles in the queue. The first hold off actuator includes a movable arm 91 pivotally attached at 92 to frame 40 above the lowermost queue of containers. Arm 91 is operated using linkages 94 attached to a gear motor or other suitable motion imparting device 93 that is capable of raising and lowering arm 91 about pivot 92. The second hold off actuator includes a movable arm 95 pivotally attached at 96 to frame 40 above the lowermost queue of containers. Arm 95 is operated using similar linkages 94 attached to a similar gear motor or other suitable motion imparting device 93 that is capable of raising and lowering arm 95 about pivot 96. A shield drop 97 is provided to prevent tempering with the internal mechanism while the tray is open.

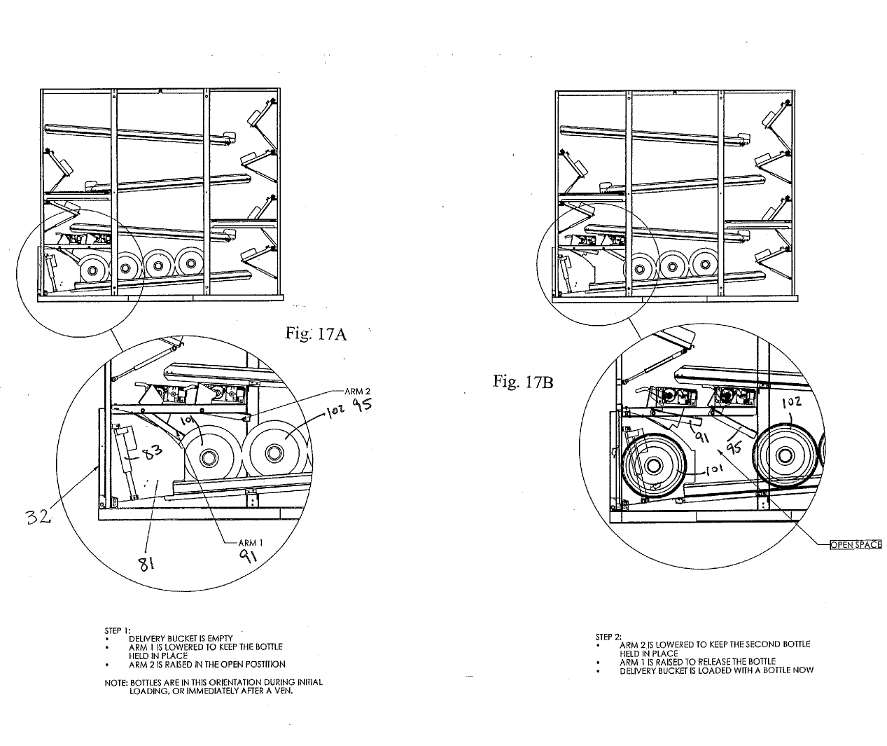

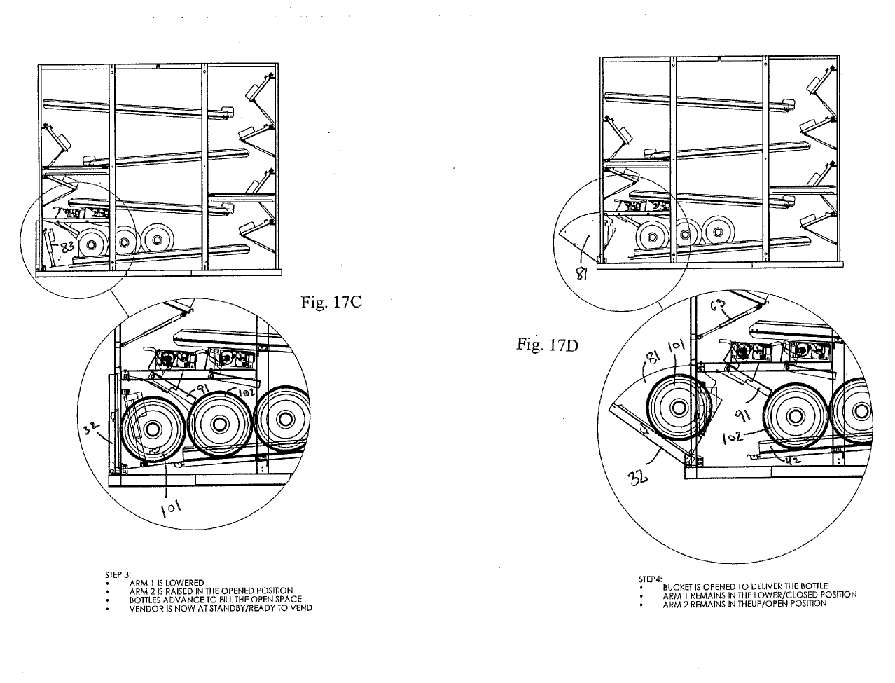

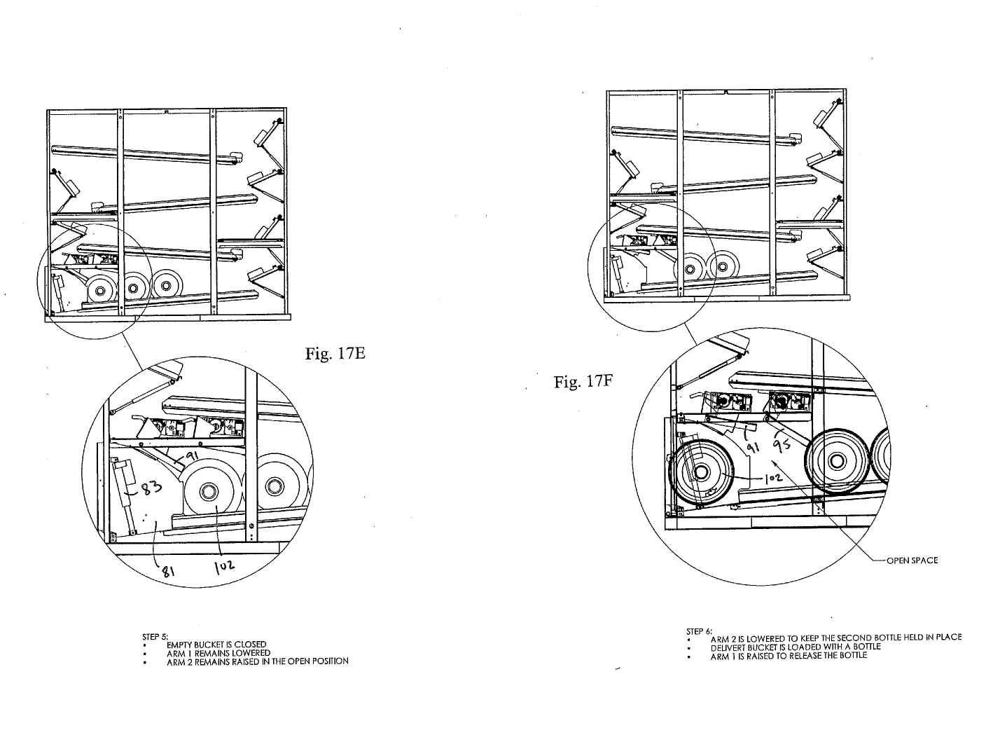

FIGS. 17A-E depict a set of views of an exemplary embodiment of a delivery mechanism in operation. It is to be noted that, among other things, these illustrations do not depict the processor or sensors 89, nor any of the programming or circuitry needed to control operation of the delivery mechanism. Referring first to FIG. 17A, it is seen that tray 81 is empty, and that arm 91 has been lowered in order to hold off the frontmost container (bottle) 101. Arm 95 is in a raised position, having allowed container 101 to reach arm 91 by the force of gravity. Following appropriate instructions from a user at the interface, the processor receives a signal to deliver a product container. In response, second arm 95 is moved down to hold off second container (bottle) 102 and those behind it, while first container 101 is delivered. The first arm 91 is then raised to allow container 101 to travel by gravity into tray 81, as shown in FIG. 17B, ready for delivery. First arm 91 is then lowered, and second arm 95 is then raised allowing second container 102 to travel by gravity to first arm 91 where it is held off, as shown in FIG. 17C. The presence of container 101 is detected in tray 81 by the action of sensor 89 and plate 85. Once the container is sensed in delivery tray 81, the tray is rotated outward on pivot 82 making container 101 available for removal by a user as shown in FIG. 17D. If no container is sensed, this is an indication that the queue is empty such that tray 81 will not be rotated out, and the user will receive an appropriate message at the user interface. After the container is removed from tray 81, this is sensed by sensor 89, and tray 81 is rotated back to a closed position, as shown in FIG. 17E. This is the same “ready to vend” position as FIG. 17A, with the next container 102 ready in the first position.

In some embodiments, the such as those illustrated in FIGS. 17F-G, the “ready to vend” position calls for the frontmost product container to be rotated into tray 81 for immediate delivery, instead of being held off by arm 91. In these embodiments, after tray 81 has been closed, the frontmost product container (in this case 102), is moved into tray 81. This is accomplished by lowering second arm 95 to hold off other product containers in the queue, and raising arm 91 to allow the frontmost container 102 to roll by gravity into tray 81, as shown in FIG. 17F. Then, the remaining queue of containers is advanced by the lowering of first arm 91, and the raising of second arm 95 which brings all remaining bottles forward by gravity as shown in FIG. 17G.

It is to be appreciated that the exact sequence of events for holding off and delivering the frontmost product container may be varied from the sequences above. For example, and without limitation, after a container 101 is placed into tray 81, the tray 81 may then be opened to allow the container to be removed, and may also be closed following removal of the container, before any further action is taken by arms 91 or 95 to move a second bottle into position behind arm 91. It is to be appreciated that other variations in the sequences of these steps may be made within the scope of the invention.

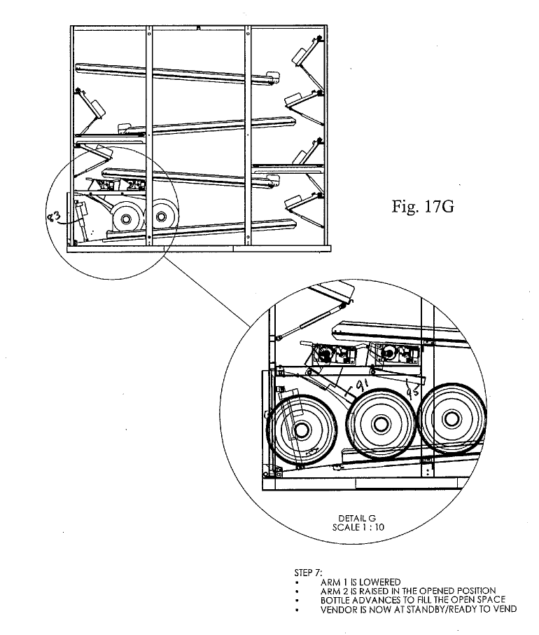

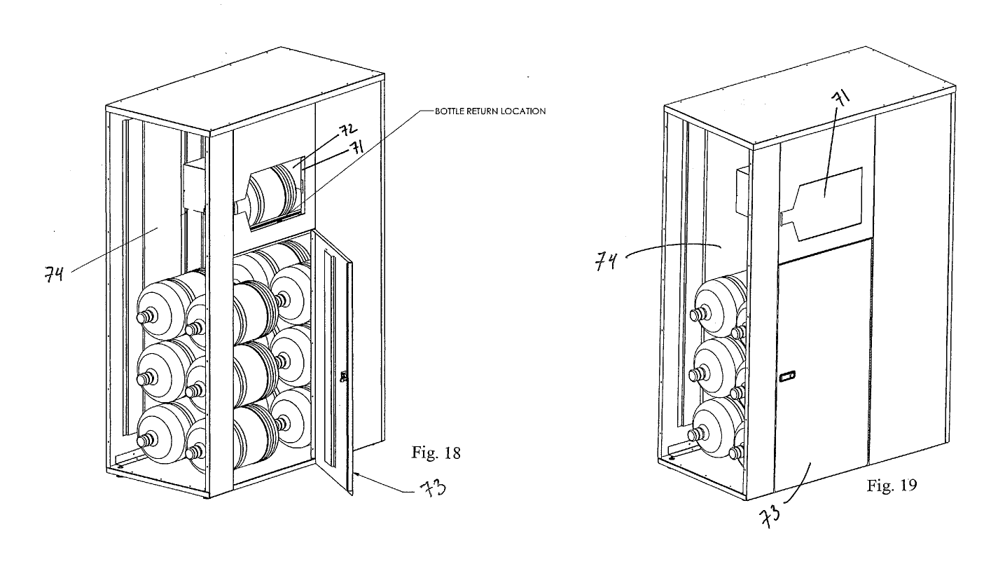

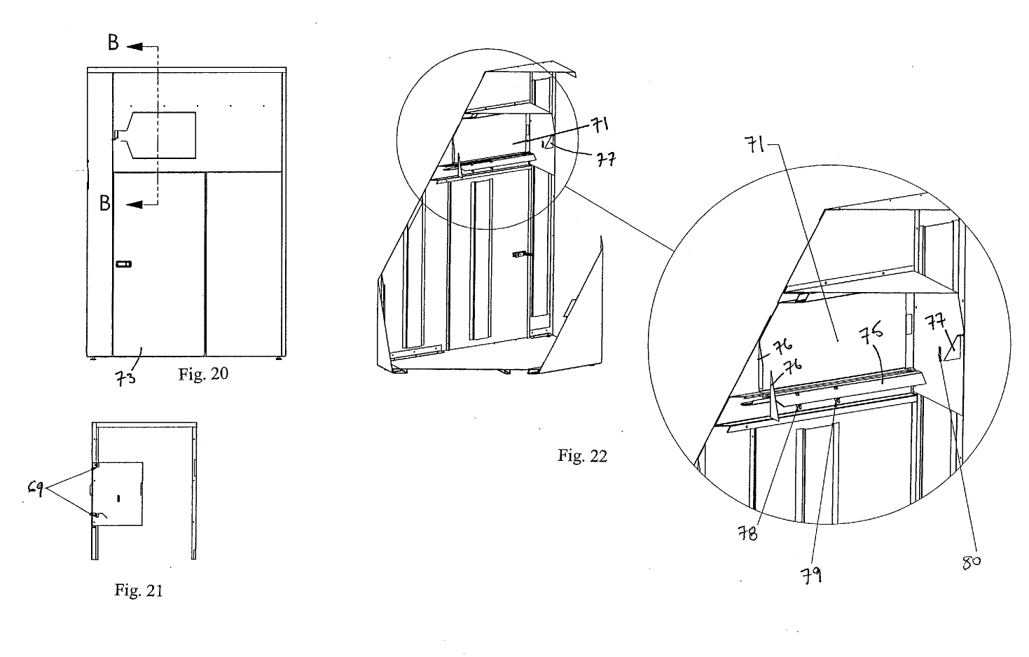

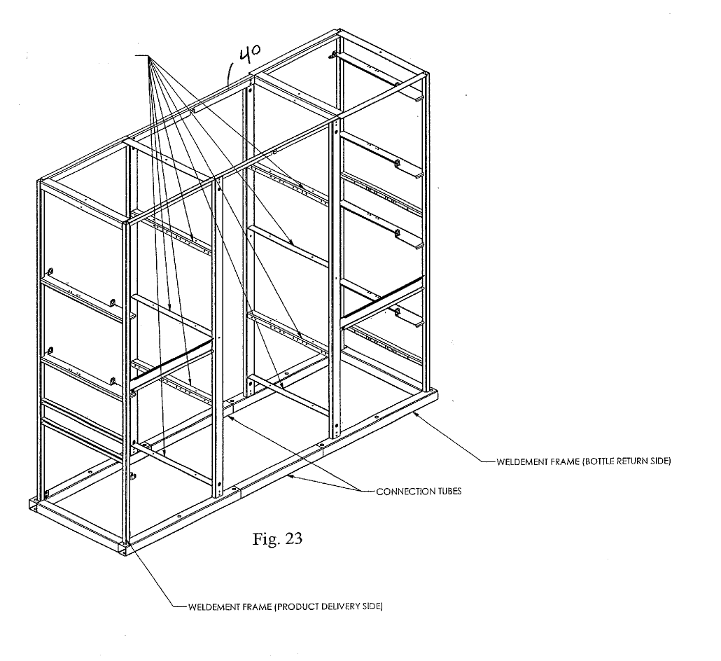

An embodiment of a return unit 70 is illustrated in FIGS. 18-22. A lock on closable door 71 is controlled by the processor. Door 71 may be provided on track wheels 69 behind an opening 72 that is preferably shaped in the form of a bottle, preferably having the bottle neck area to one side, and the bottle bottom area to the other side, as shown in FIGS. 18, 19 and 20. A user may activate cause the door to be unlocked for a return at the user interface. Once unlocked, door 71 may be slid open by the user and an empty container inserted as shown in FIG. 18. A bottom guide 75, a set of lower brackets 76 and an upper bracket 77 are provided for cradling a properly inserted container, as shown in FIG. 22. Two lower sensors or switches 78, 79 are provided on guide 75, and another sensor or switch 80 is provided adjacent to upper bracket 77 to sense the presence and size of the returned container. Ordinarily, the user inserts the return bottle into guide 75 and closes the door 71, which causes the sensors to be activated. Sensor 80 is used to detect the proper placement of the neck of a bottle; sensor 79 is used to detect the bottom of a smaller 3-gallon bottle, and sensor 78 is used to detect the bottom of a larger 5-gallon bottle. Once a properly oriented bottle has been detected, a movable support bracket (not shown) inside unit 70 is moved out of the way using a suitable actuator, allowing the returned container to drop into bin 74, and a credit is issued at the user interface. If the bottle is misaligned or otherwise not properly sensed, an appropriate message to this effect (e.g. “please check returned container position”) is provided to the user at the interface.

It is to be appreciated that opening 72 may be provided in other forms or shapes corresponding to other container or bottle forms or shapes, and that different or additional guides and sensors/switches may be provided inside to detect the presence and orientation of such different product containers.

In some embodiments, dual or tandem vending units 30 which may include one or two return units 70 may be provided under the control of a single processor and a single user interface. In such embodiments, both vending units 30 may be configured to deliver the same sized containers (e.g. both vend 5-gallon containers), or one may be configured differently from the other to provide different sized containers (3-gal. and 5-gal.). Similarly, the return units 70 may be configured to receive either sized containers (e.g. 3-gallon or 5-gallon containers), or one may be configured differently from the other to receive different sized containers (3-gal. and 5-gal.). Multiple vending and multiple return units, and different combinations of vending and return units, are contemplated within the scope of the invention, all of which may be operated by a single processor.

Prior to loading a typical vending unit 30 of the present invention, rails 41 and 42 are moved to the proper orientation for the size of container to be loaded. If necessary, one or more guides 58 are attached to damper panels 51, 61 to correspond to the size of container to be used. End pieces 45 are attached to rails 41, 42 near the dampers. Upper door 31 is unlocked and opened, and full container bottles are individually inserted into the unit 30, traveling by gravity down rails 41, 42 and through the damping mechanisms at each corner so as not to gain too much speed which could cause damage to the containers and/or the machine. First hold off arm 91 receives and stops the first such container 101, and other containers queue up behind it, as shown in FIGS. 13 and 17A. In some embodiments, hold off arms 91 and 95 may operate to move the frontmost product container into tray 81 for immediate delivery, as shown in FIG. 17F-G. Once frame 41 is filled with product containers, door 31 is closed and locked, and the user interface is activated.

To use a typical vending unit 30 of the present invention, a user operates the interface 35 to select (if multiple units 30 are available with different products) and pay for a product container. Once payment is confirmed, the processor causes arms 91 and 95 to operate in order to allow the frontmost product container 101 to be delivered into tray 81. The remaining containers in the queue may be moved forward at that time, or after tray 81 has been opened, or after tray 81 has been closed. Sensor 89 in tray 81 confirms that a full product container is in the tray, and it is opened so that the user may remove the product container. Once removed, sensor 89 recognizes that there is no longer pressure in the tray, which results in tray 81 being closed. If an object (such as the user's hand) is placed in the tray, before being completely closed, sensor 89 will be activated stopping tray 81 from closing, and reversing the tray to an open position to allow the blockage to be removed. The processor will wait until there is no blockage sensed before trying to close the tray. If no product is sensed as having been delivered to the tray 81 (or in the embodiments of FIGS. 17F-G, if it is already been sensed that there are no more containers in the queue), the user is notified at the interface.

To return a product, the user activates the user interface which results in the unlocking of door 71 of return unit 70. The user then opens the door, inserts the product container into the guide, and closes the door. The container size and orientation are sensed by sensors 77-79. If a properly oriented product container is sensed, it is received into bin 74, and the user is given a credit at the user interface that may be used toward the next purchase from vending unit 30. If the container is misaligned or otherwise not properly sensed, an appropriate message to this effect (e.g. “please check returned container position”) is provided to the user at the interface. An operator may unlock and open door 73 to remove collected containers from bin 74 for reuse or disposal.

It is to be understood that variations and modifications of the present invention may be made without departing from the scope hereof, and that one or more of the different embodiments disclosed herein may be used together with one or more of the other embodiments to provide additional features for the vending machine. It is also to be understood that the present invention is not to be limited by the specific embodiments or combinations of embodiments, components or parts disclosed herein, nor by any of the exemplary embodiments or combinations set forth in the attached illustrations.

What is claimed is:

1. An apparatus for transferring large heavy product containers from one level to another comprising:
a. a frame comprising a plurality of pairs of rails for supporting said product containers, said rails defining a path having at least one turn therein;
b. a damper located at a turn in said path for slowing the movement of said product containers on said path, said damper comprising:
1) a panel having an end thereof pivotally attached to said frame;
2) at least one spring for urging said panel to an extended position; and
3) a compressible support member attached between said panel and said frame, said compressible member being capable of contracting in a predetermined manner to control the pivotal movement of said panel when said panel is contacted by a large heavy product container in order to retard the movement of said container on said path.

2. The apparatus of claim 1 wherein a stop is provided between said panel and said frame to prevent pivotal movement of said panel beyond said stop.

3. The apparatus of claim 1 wherein said compressible support member is a shock absorber.

4. The apparatus of claim 1 wherein said compressible support member is selected from the group of: an air filled cylinder, a gas filled cylinder, and an oil filled cylinder.

5. The apparatus of claim 1 wherein said compressible support member is a spring.

6. The apparatus of claim 1 wherein flanges are provided on opposite sides of said panel to guide said large heavy product container when in contact with said panel.

7. The apparatus of claim 6 wherein the rails of said plurality of pairs of rails are adjustable to accommodate different sized product containers, and at least one removable guide flange is provided on said damper panel for alignment with each such adjusted rail.

8. The apparatus of claim 7 wherein a cross member is provided between said pair of rails at an end of said rails adjacent to said damper.

9. The apparatus of claim 1 further comprising a second damper located below said first damper for further slowing the movement of said product containers on said path, said second damper comprising:
1) a second panel having an end thereof pivotally attached to said frame below said first damper;
2) at least one spring for urging said second panel to an extended position; and
3) a second compressible support member attached between said second panel and said frame, said second compressible member being capable of contracting in a predetermined manner to control the pivotal movement of said second panel when said panel is contacted by a large heavy product container in order to further retard the movement of said container on said path.

10. The apparatus of claim 9 wherein a stop is provided between said second panel and said frame to prevent pivotal movement of said second panel beyond said stop.

11. The apparatus of claim 9 wherein said second compressible support member is a shock absorber.

12. The apparatus of claim 9 wherein said compressible support member is selected from the group of: an air filled cylinder, a gas filled cylinder, and an oil filled cylinder.

13. The apparatus of claim 9 wherein said compressible support member is a spring.

14. The apparatus of claim 9 wherein flanges are provided on opposite sides of said second panel to guide said large heavy product container when in contact with said second panel.

15. The apparatus of claim 14 wherein the rails of said plurality of pairs of rails are adjustable to accommodate different sized product containers, and at least one removable guide flange is provided on each of said first and second damper panels for alignment with such adjusted rails.

16. The apparatus of claim 15 wherein a cross member is provided between said pair of rails at an end of said rails adjacent to said second damper.

17. An apparatus for vending large heavy product containers comprising:
a. a frame comprising a plurality of pairs of rails for supporting said product containers, said rails defining a path inside said frame;
b. a delivery port located at a lower end of said path comprising:
1) a pivotally mounted tray for receiving a frontmost large product container;
2) a first movable restraining member attached to said frame adjacent to said delivery port for controlling entry of said frontmost product container into said tray;
3) a second movable restraining member attached to said frame adjacent to said first restraining member for controlling movement of a subsequent product container;
c. a sensor in said tray for detecting the presence of a product container in said tray and for detecting whether said tray is clear of blockage after removal of a product container from said tray;
d. a movable mechanical member attached to said tray for opening and closing said tray; and
e. a processor in communication with said sensor having programming to control the operation of said movable mechanical member and said first and second restraining members.

18. The apparatus of claim 17 wherein a movable panel is provided in said tray, and said sensor is provided between said tray and said movable panel such that said sensor detects the presence of an object in said tray by the movement of said panel.

19. The apparatus of claim 17 wherein said movable mechanical member is selected from the group of a motor, a linkage, a cam, and a piston.

20. The apparatus of claim 18 wherein said movable panel is urged away from said sensor using at least one spring.

21. The apparatus of claim 20 wherein a stop is provided on said tray to prevent movement of said panel beyond said stop.

22. The apparatus of claim 17 wherein said sensor is a switch.

23. The apparatus of claim 17 further comprising a damper located at a turn in said path for slowing the movement of said product containers on said path, said damper comprising:
a. a panel having an end thereof pivotally attached to said frame;
b. at least one spring for urging said panel to an extended position; and
c. a compressible support member attached between said panel and said frame, said compressible member being capable of contracting in a predetermined manner to control the pivotal movement of said panel when said panel is contacted by a large heavy product container in order to retard the movement of said container on said path.

24. The apparatus of claim 23 further comprising a second damper located below said first damper for further slowing the movement of said product containers on said path, said second damper comprising:
a. a second panel having an end thereof pivotally attached to said frame below said first damper;
b. at least one spring for urging said second panel to an extended position; and
c. a second compressible support member attached between said second panel and said frame, said second compressible member being capable of contracting in a predetermined manner to control the pivotal movement of said second panel when said panel is contacted by a large heavy product container.

25. The apparatus of claim 24 wherein the rails of said plurality of pairs of rails are adjustable to accommodate different sized product containers, and at least one removable guide flange is provided on each of said first and second damper panels for alignment with such adjusted rails.

26. An apparatus for receiving returned empty large product containers comprising:
a. a cabinet including a lower storage area and a closable upper entry door having a releasable lock thereon;
b. a guide located inside said door for aligning product containers inserted through said door;
c. a plurality of sensors in said guide for detecting the presence of a product container in said guide;
d. a movable bracket adjacent to said guide for allowing product containers to be transferred from said guide to said storage area; and
e. a processor in communication with said door lock, said sensors and a actuator associated with said movable bracket, for controlling said lock, detecting the presence and size of a product container, and moving said bracket.

27. The apparatus of claim 26 wherein said guide comprises an opening in the shape of a product container wherein a neck area is at one side adjacent to a body area.

28. The apparatus of claim 27 wherein a first sensor is provided in the neck area of said guide, a second sensor is provided at a position in said body area to detect a bottom of a small product container and a third sensor is provided at a position in said body area to detect a bottom of a large product container.

29. The apparatus of claim 26 further comprising:
a. a second cabinet including a second lower storage area and a second closable upper entry door having a releasable lock thereon;
b. a second guide located inside said second door for aligning product containers inserted through said second door;
c. a plurality of additional sensors in said second guide for detecting the presence of a product container in said second guide; and
d. a second movable bracket adjacent to said guide for allowing product containers to be transferred from said guide to said storage area;
wherein said processor is in communication with said second door lock, said additional sensors and an actuator associated with said second movable bracket, for controlling said lock, detecting the presence and size of a product container, and moving said bracket.

30. The apparatus of claim 24 further comprising:
a. a return cabinet including a lower storage area and a closable upper entry door having a releasable lock thereon;
b. a guide located inside said door for aligning product containers inserted through said door;
c. a plurality of sensors in said guide for detecting the presence of a product container in said guide;
d. a movable bracket adjacent to said guide for allowing product containers to be transferred from said guide to said storage area; and
e. a processor in communication with said door lock, said sensors and a actuator associated with said movable bracket, for controlling said lock, detecting the presence and size of a product container, and moving said bracket.

31. A method for damping the movement of a large heavy product container as it is transferred from an upper level to a lower level of a support frame comprising the steps of:
a. contacting a heavy product container with a damper on a path on an upper level, said damper comprising:
1) a panel having an end thereof pivotally attached to said frame,
2) at least one spring for urging said panel to an extended position, and
3) a compressible support member attached between said panel and said frame;
b. moving said compressible support member in a predetermined manner to retard the movement of said panel following contact with said container; and
c. progressively transferring said product container from said upper level to a lower level while in contact with said panel.

32. The method of claim 31 wherein a stop is provided between said panel and said frame to prevent pivotal movement of said panel beyond said stop.

33. The method of claim 31 comprising the additional step of returning said panel to an extended position after said container has been transferred.

34. The method of claim 31 comprising the additional steps of:
d. contacting said heavy product container with a second damper located below said first damper, said second damper comprising:
1) a second panel having an end thereof pivotally attached to said frame,
2) at least one second spring for urging said second panel to an extended position, and
3) a second compressible support member attached between said second panel and said frame;
e. moving said second compressible support member in a predetermined manner to retard the movement of said second panel following contact with said container; and
f. progressively transferring said product container from said upper damper to a lower level while in contact with said second panel.

35. The method of claim 34 wherein a stop is provided between said second panel and said frame to prevent pivotal movement of said second panel beyond said stop.

36. The method of claim 34 comprising the further step of maintaining the orientation of said heavy product container using at least one flange on at least one of said panels.

37. A method for returning a large empty product container by a computer controlled system comprising the steps of:
a. receiving an activation signal that a container is to be returned;
b. releasing a closed return door in response to said signal;
c. receiving the container to be returned through said door;
d. sensing the alignment of the container received;
e. if the container is sensed as properly aligned, then depositing said container into a bin and providing a credit for the container; and
f. if the container is sensed as not being properly aligned, then sending a signal to re-align the container.

38. The method of claim 37 comprising the additional steps of:
g. sensing the size of said container; and
h. if the container is sensed as properly aligned, calculating the amount of credit for the container based upon the size sensed.

39. A method for vending a large reusable product container from an inclined queue of such containers by a computer controlled system comprising the steps of:
a. receiving an activation signal that a product container is to be delivered;
b. activating a first movable member to hold off a second and subsequent product containers of said queue in place;
c. activating a second movable member to release a first product container from said queue so that it is transferred into a delivery tray;
d. activating said second movable member to hold off any subsequent containers in said queue;
e. activating said first movable member to release a second product container from said queue so that it moves forward and is then held off by said second movable member;
f. opening said tray when the presence of a container in the tray is sensed; and
g. closing said tray when the presence of a container in the tray is no longer sensed.

40. The method of claim 39 comprising the additional step of suspending the closing of said tray if the presence of an object is sensed in said tray.

41. The method of claim 39 comprising the additional steps of:
h. contacting a heavy product container on an upper level on said queue with a damper, said damper comprising:
1) a panel having an end thereof pivotally attached to said frame,
2) at least one spring for urging said panel to an extended position, and
3) a compressible support member attached between said panel and said frame;
i. moving said compressible support member in a predetermined manner to retard the movement of said panel following contact with said container; and
j. progressively transferring said product container from said upper level to a lower level while in contact with said panel.

42. The method of claim 41 wherein a stop is provided between said panel and said frame to prevent pivotal movement of said panel beyond said stop.

43. The method of claim 41 comprising the additional steps of:
k. contacting said heavy product container on said queue with a second damper located below said first damper, said second damper comprising:
1) a second panel having an end thereof pivotally attached to said frame below said first damper,
2) at least one second spring for urging said second panel to an extended position, and
3) a second compressible support member attached between said second panel and said frame;
l. moving said second compressible support member in a predetermined manner to retard the movement of said second panel following contact with said container; and
m. progressively transferring said product container from said first damper to a lower level while in contact with said second panel.

44. The method of claim 43 wherein a stop is provided between said second panel and said frame to prevent pivotal movement of said second panel beyond said stop.
